(19) United States
(12) Patent Application Publication
(10) Pub. No.: US 2025/0353065 A1
(43) Pub. Date: Nov. 20, 2025

(54) MOTOR VEHICLE COMPONENT AND METHOD FOR ITS PRODUCTION BY HOT CUTTING

(71) Applicant: BENTELER AUTOMOBILTECHNIK GMBH, Paderborn (DE)

(72) Inventors: Christian BUSE, Lichtenau (DE); Guenter FORTMEIER, Delbrueck (DE); Oliver LUETKEMEYER, Paderborn (DE); Feng JIAO, Paderborn (DE)

(21) Appl. No.: 19/210,287

(22) Filed: May 16, 2025

(30) Foreign Application Priority Data
May 17, 2024 (EP) 24176696.3

(51) Int. Cl. B21D 28/16; B21D 24/16; B21D 53/88; B62D 25/04

(52) U.S. Cl. CPC B21D 28/16; B21D 53/88; B62D 25/04; B21D 24/16

(57) ABSTRACT

A motor vehicle component, produced by hot forming and press hardening from a hardenable steel sheet plate, and the motor vehicle component has a reinforcement patch which forms a double layer with the steel sheet plate at least in sections. The motor vehicle component has, in the region of the reinforcement patch, a continuous opening produced by hot cutting, such that an opening is formed in the reinforcement patch and an opening in the steel sheet plate, wherein the edge area surrounding the opening is embossed on the steel sheet plate or the reinforcement patch so as to be set back from the further surface.

### RELATED APPLICATIONS

The present application claims priority of European Application Number 24176696.3 filed May 17, 2024, the disclosure of which is hereby incorporated by reference herein in its entirety.

### BACKGROUND

The present disclosure relates to a motor vehicle component manufactured by hot forming and press hardening.

The present disclosure further relates to a method for the production of the motor vehicle component.

Hot forging and press hardening technology is used in the automotive industry to produce sheet metal components for body construction or other motor vehicle components.

For this purpose, a sheet metal plate made of a hardenable steel alloy is heated to above Ac3 temperature. This is around 900° C. or higher, and is also called austenitization. In this warm state, the component is easy to form. This is called hot forming.

Once the component has been formed, is the component is press-hardened in the next step. This process is also able to be called quench hardening, and is cooled at a cooling rate, also referred to as the critical cooling rate, from the temperature above the austenitizing temperature so rapidly that the previously austenitic structure is transformed into a hardened structure, for example, a martensitic structure. Here, tensile strengths Rm of more than 1000 MPa, more than 1300 MPa and, depending on the steel alloy used, also more than 1500 MPa or more than 1800 MPa is able to be achieved.

Depending on the requirements, high-strength or ultra-high-strength components are able to be reinforced. For this purpose, component patches or reinforcement patches are applied locally. The component patches themselves are also able to be made of a hardenable steel alloy. However, the component patches are also able to be made of another metallic alloy, for example, a steel alloy. In at least one embodiment of the present disclosure, the actual motor vehicle component, made from the steel sheet plate, is formed together with the reinforcing sheet. The reinforcement patches are able to be coupled to the sheet steel plate, for example, by welding or gluing.

Furthermore, motor vehicle components are able to be cut or punched in an interior area. These are able to, for example, be openings for passing through cables, connecting other components or other assembly openings or installation openings for additional components.

Furthermore, the hot cutting, a sheet steel plate is cut or punched in the warm state, i.e., at austenitizing temperature, or in a residually warm state, i.e., in a state before complete hardening. Therefore, the hot cutting process takes place before, during or after hot forming, but before press hardening.

From DE 10 2011 105 514 A1 a motor vehicle component with a reinforcement patch and a method are described.

### SUMMARY

The object of the present disclosure demonstrates a hot-cutting a reinforced component precisely and cost-effectively.

The aforementioned object is achieved according to the present disclosure.

The present disclosure thus provides that a motor vehicle component is produced by hot forming and press hardening from a hardenable steel sheet plate. The motor vehicle component is a motor vehicle pillar, for example, an A-pillar, B-pillar or C-pillar, a roof frame or windshield frame. However, the motor vehicle component is also able to be other body components or chassis components of a motor vehicle.

This motor vehicle component has a reinforcement patch which forms a double layer with the steel sheet plate, at least in sections. Thus, the motor vehicle component is locally reinforced at various points by means of corresponding reinforcement patches. The motor vehicle component is produced by hot forming and press hardening and has a tensile strength locally of at least Rm greater than 1000 MPa, 1300 MPa, or greater than 1500 MPa.

According to the present disclosure, the motor vehicle component is characterized in that the motor vehicle component has an opening produced by hot cutting in the region of the reinforcement patch. The opening is made continuous, meaning that the opening extends through the entire wall thickness. The material is thus completely cut out in the area of the opening. Instead of hot cutting, hot piercing is also able to be performed, for example, if the opening is round or circular. However, the opening is also able to be elliptical or polygonal. The opening thus passes through the formed steel sheet plate and the reinforcement patch. These two openings, i.e., the opening of the sheet steel plate and the opening of the reinforcement patch, are aligned. In at least one embodiment of the present disclosure, the two openings have the same geometric dimensions because they are made with a cutting tool or punch.

In at least one embodiment of the present disclosure, the edge area surrounding the opening is embossed on a component, thus, on the formed sheet steel plate or the reinforcement patch, set back from the further surface. The indentation is created by pure material displacement. There is no separation or cutting process in the sense of the imprinting. In at least one embodiment of the present disclosure, this means that the surface surrounding the opening is set back or embossed in the direction of the wall. According to the present disclosure, the occurrence of burr formation during hot cutting or hole punching are able to be compensated. Carrying out a corresponding cutting or hole punching process in the area of the double layer is difficult. On the one hand, the back-embossing reduces the overall wall thickness in this area, and on the other hand, any burr formation is no longer protruding and therefore does not protrude beyond the component surface.

The recessed indentation is recessed by 4% to 40%, 8% to 35%, or 12% to 30% relative to the further surface surrounding the indentation itself. The 4% to 20% refers to the wall thickness of the steel sheet plate with embossing or the reinforcement patch.

In at least one embodiment of the present disclosure, “circumferential” means that the indentation is formed over at least a partial circumferential length of the opening or the hole edge. This should be at least 30%, at least 50%, at least 70%, and completely circumferential. In at least one embodiment of the present disclosure, the imprint includes partial segments over several partial circumference lengths.

The indentation extends in the radial direction, i.e., in the direction of the wall thickness itself in the direction of the component or in the radial direction protruding from the opening, i.e., in the transverse direction radially circumferential and at least 0.5 mm, more than 1 mm. However, the indentation should protrude less than 5 mm radially. Any tolerances during the cutting process are thus able to be compensated for, so that when the indentation is first created on the raw material, i.e., the flat steel sheet plate or the reinforcement patch, care is taken to ensure that the subsequent cutting process is carried out safely in the area of the indentation.

Furthermore, the hole edge of the opening after press hardening has a burr whose length is less than 0.3 mm, less than 0.2 mm. In at least one embodiment of the present disclosure, the opening is formed almost burr-free by hot cutting, for example, in combination with the embossing and the resulting reduced wall thickness on the side of the exit of the cutting tool or punch. In at least one embodiment of the present disclosure, a burr is formed, in the opening produced by hot cutting or hot punching. This ridge is then formed offset into the indentation. An additional form fit is thus provided by the burr.

Furthermore, the wall of the opening has a smooth cut proportion of greater than 25%, greater than 40%. In at least one embodiment of the present disclosure, the smooth cut proportion is approximately >50%. This refers to the wall of the entire opening. This is therefore formed from the double layer of the steel sheet plate and the reinforcement patch. In at least one embodiment of the present disclosure, the steel sheet located on the single-hole side or punch side (i.e., either the reinforcement sheet or the steel sheet plate) has a burr-free opening with almost 100% smooth cutting.

In at least one embodiment of the present disclosure, a piercing nut is able to be inserted into the opening. The piercing nut would then take over the punching of the opening itself and remain in the component.

The aforementioned component according to the present disclosure is manufactured using a method having the following features:
Providing a hardenable steel sheet plate and a reinforcement patch,
Coupling the two parts in such a way that the steel plate and the reinforcement patch form a double layer,
Heating to above Ac3 temperature, wherein the indentation is introduced after heating and before hot forming or during hot forming,
Hot forming, wherein the cutting operation is carried out during or after hot forming,
Hot cutting wherein a cutting tool cuts on the back of the indentation and ejects the cutout on the side of the indentation,
Press hardening of the formed motor vehicle component.

Thus, first the steel sheet plate made of a hardenable steel alloy and a reinforcement patch, which is also able to be made of a hardenable steel alloy, are provided.

An indentation is made in one of the components in the area where the opening is to be created later. This is able to be done on an embossing tool. Embossing is a reduction of the wall thickness through an embossing process. In at least one embodiment of the present disclosure, the embossing is carried out after heating to Ac3 temperature. The indentation is thus able to be introduced into the material in a soft structural state. The indentation is then embossed in the hot forming tool itself. For example, there is a projection of the hot forming tool so that the indentation is produced, the component remains in the hot forming tool in the hot forming state and a corresponding hole is made by a punch, at least on the opposite side.

The two parts, i.e., the sheet steel plate and the reinforcement patch, are then coupled together, for example, this is able to be done by welding or gluing.

Heating to above Ac3 temperature or austenitization then takes place. The mold material thus prepared is then placed into a hot forming tool. During or after the hot forming process, hot cutting or hot piercing takes place. A corresponding cutting tool, which is also able to be a hole punch, for example, is placed on the back of the indentation starting with the cutting or punching process in such a way that the cutout is ejected on the side of the indentation. Any burr formation is set back from a surface due to the fact that the indentation is larger in its geometric extent than the opening to be created.

During hot cutting, the punch is able to penetrate the double layer completely, wherein a retraction is able to occur directly after the single-punch movement in order to avoid shrinkage of the hole edge onto the punch. Likewise, unwanted, prolonged contact between the hole edge and the punch surface during the return movement are able to be avoided by optimizing the punch surface, for example, by slightly conically widening the punch geometry towards the punch tip.

The motor vehicle component produced by hot forming and hot cutting is then press hardened and removed from the hot forming and press hardening tool.

The indentation itself is also able to be formed on both sides, i.e., on the side of the punch and on the opposite side. This promotes the initial cutting process during the first impact of the punch as well as the formation of burrs on the entry and exit sides of the punch.

In at least one embodiment of the present disclosure, the indentation is created only in the cutting edge area. The indentation is then ring-shaped or follows the desired contour of the opening.

The cutting process is carried out at a temperature between 480° C. and 800° C., 500° C. to 800° C., or between 600° C. and 730° C. The latter temperature intervals ensure a very high proportion of smooth cutting and the absence of burrs at least in the opening of the steel sheet on the single-hole side. In addition, the latter temperature intervals are advantageous with regard to tool wear. To prevent tool wear, the punch itself and also the punching die or the tool projection producing the indentation is able to be plated with a protective layer, for example, with a ceramic coating.

### BRIEF DESCRIPTION OF THE DRAWINGS

Further advantages, features, properties and aspects of the present disclosure are described in the following figures. These facilitate the understanding of the present disclosure.

### in the Figures:

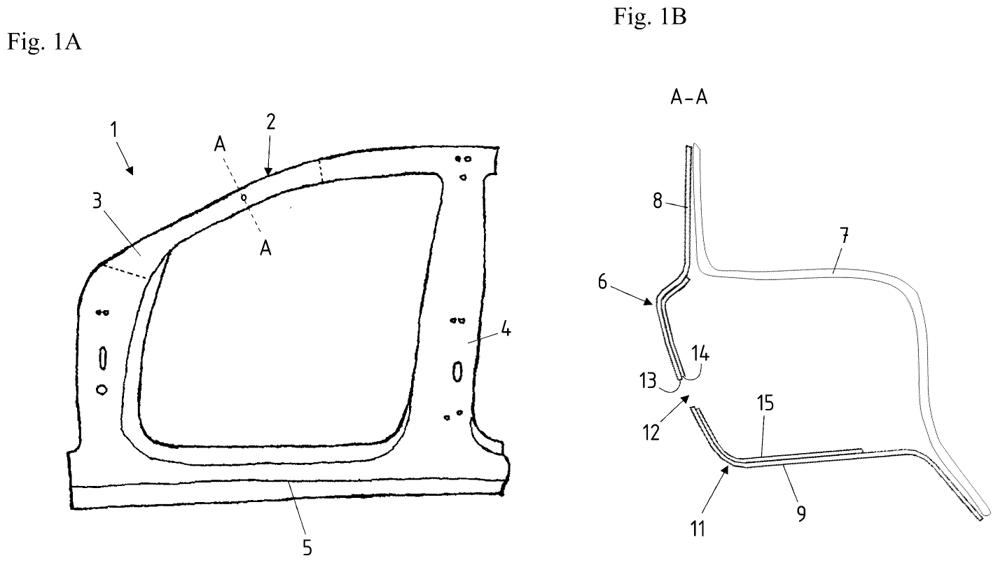

FIG. 1A and FIG. 1B show the use of a reinforcing component according to at least one embodiment of the present disclosure of a motor vehicle component,

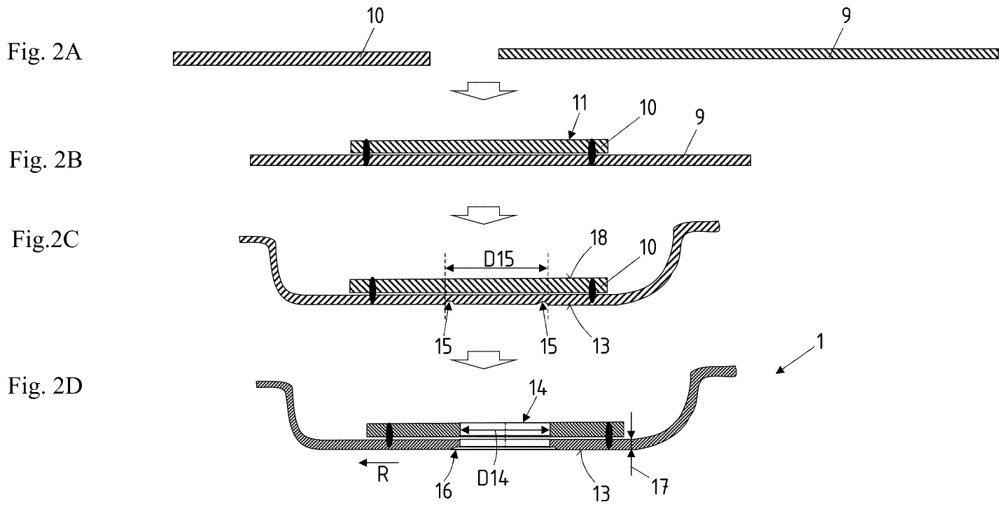

FIG. 2A to FIG. 2D show a method sequence according to at least one embodiment of the present disclosure for producing a motor vehicle component according to at least one embodiment of the present disclosure with the introduction of an indentation.

### DETAILED DESCRIPTION

In the figures, the same reference numerals are used for same or similar components, although a repeated description or illustration

is omitted for reasons of simplicity. The features mentioned above and described below are able to be combined with each other as desired without departing from the scope of the present disclosure.

In at least one embodiment of the present disclosure, a steel alloy is selected for the steel sheet plate as an alternative or in addition for the reinforcement patch, which is described, for example, as steel A, B, C or D in the table described below. The other of the two plates are then able to be made of the same steel, but also of one of the non-hardenable steels E or F. The alloying elements are given in wt. %, the remainder being iron and impurities due to melting;

| | C | | Si | | Mn | | P | S | Al | | B | | Cr |
|---|---|---|---|---|---|---|---|---|---|---|---|---|---|
| | min | max | min | max | min | max | max | max | min | max | min | max | min |
| Stahl A | 0.19 | 0.25 | 0.1 | 0.4 | 1.1 | 1.4 | 0.02 | 0.005 | 0 | 0.06 | 0.004 | 0.1 | |
| Stahl B | 0.2 | 0.23 | 0.2 | 0.3 | 1.1 | 1.4 | 0.02 | 0.005 | 0 | 0.06 | 0.004 | 0.1 | 0.1 |
| Stahl C | 0.31 | 0.37 | 0.1 | 0.6 | 1 | 1.5 | 0.025 | 0.02 | | 0.1 | 0.001 | 0.004 | 0.08 |
| Stahl D | 0.33 | 0.35 | 0.15 | 0.35 | 1 | 1.5 | 0.025 | 0.015 | 0.01 | 0.08 | 0.001 | 0.004 | 0.08 |
| Stahl E | 0.06 | 0.13 | | 0.7 | | 1.9 | 0.05 | 0.05 | | 0.1 | | 0.003 | |
| Stahl F | 0.07 | 0.11 | 0.02 | 0.6 | 1.2 | 1.6 | 0.03 | 0.01 | 0.01 | 0.07 | 0.0007 | 0.002 | |

| | | Cu | N | Nb | | Ni | | Ti | | V | Mo |
|---|---|---|---|---|---|---|---|---|---|---|---|
| | max | max | max | min | max | min | max | min | max | max | max |
| Stahl A | 0.3 | 0.1 | | | 0.05-Ti | 0.02 | 0.1 | 0.01 | 0.1 | | 0.35 |
| Stahl B | 0.3 | 0.1 | 0.01 | | 0.05-Ti | 0.02 | 0.1 | 0.02 | 0.05 | 0.01 | 0.35 |
| Stahl C | 0.35 | 0.2 | 0.2 | | 0.1 | | 0.2 | 0.002 | 0.05 | | 0.35 |
| Stahl D | 0.5-Mo | 0.2 | 0.2 | 0.01 | 0.06 | | 0.2 | 0.005 | 0.015 | 0.01 | 0.5-Cr |
| Stahl E | 0.15 | 0.2 | 0.2 | | 0.1 | | | | 1.2 | 0.1 | 0.1 |
| Stahl F | 0.15 | 0.2 | 0.2 | 0.04 | 0.1 | | | 0.03 | 0.2 | 0.1 | 0.1 |

For all steels, a metallic pre-coating to protect against corrosion and scaling before hot forming is able to be provided, for example, an AlSi alloy or a Zn alloy or a multi-layer combination thereof.

FIG. 1A and FIG. 1B show the use of a reinforcing component according to the present disclosure of a motor vehicle component 1, here in the form of a door ring 2 or a combined A and B pillar 2, 3 with sill 5. The door ring 2 is also able to be called a door ring.

FIG. 1B shows a cross-sectional view along section line A-A. The area of the A-pillar 2 is formed in cross-section as a closed hollow profile by two adjacent hat-shaped or C-shaped profiles. An inner shell 6 is designed as the motor vehicle component 1 according to the present disclosure and is coupled to an outer shell 7 via a flange 8. The inner shell 6 is formed from an unformed steel sheet plate 9 and additionally has a reinforcement patch 10, so that a double layer 11 is formed in this area. Overall, an opening 14 is thus formed which passes through the double layer 11. For this purpose, a smaller opening 14 and a relatively larger opening 14 are formed.

FIG. 2A to FIG. 2D show the method sequence according to the present disclosure. First, a reinforcement patch 10 and a steel sheet plate 9 are provided as shown in FIG. 2A.

According to FIG. 2B, these two are coupled together to form a double layer 11. For example, spot welds 12 are able to be used for this purpose.

According to FIG. 2C, an indentation is made on the surface of the opening 11 to be produced later. The indentation has a geometric extension or geometric dimension that is larger than the later geometric dimension of the opening. If, for example, a circular opening is formed, the diameter D15 of the indentation 15 is larger than the diameter D14 of the opening 14. The indentation is able to be made over the entire surface in the area of the indentation. However, the indentation 15 is also only able to run around the edge area. For example, in the case of a round opening 14 to be produced, the indentation 15 is able to be designed as a circle which is completely embossed and thus set back from the surface 13. However, the indentation 15 is also able to be formed only in a ring shape, as shown here. The indentation 15 is able to be produced on the raw material. However, the indentation 15 is also able to be produced in the hot tool itself. Here, for example, a tool projection is able to be present so that the indentation 15 is produced during the hot forming process. A cutting or punching tool then comes from the side opposite the indentation 15 and cuts out the opening 14.

In at least one embodiment of the present disclosure, the indentation 15 is also able to be formed on both sides, i.e., on the surface 18 with reference to FIG. 2C on the outer surface 13 of the sheet steel plate 9 as well as on the outer surface 18 of the reinforcement patch 10, which, however, is not shown in more detail in FIG. 2C.

According to FIG. 2D, on the finished motor vehicle component, the indentation 15 is then set back from the surface 18 relative to a surface or the opening in the peripheral edge area 14. In the radial direction R, the indentation 15 extends radially circumferentially by more than 0.5 mm. The indentation 15 is set back from the surface 13 by 4% to 20% based on the wall thickness 17, here of the steel sheet plate 9.

A cutting punch and a cutting waste, for example, a sheet metal part punched out to create the opening, are not shown in detail for the sake of simplicity.

The foregoing description of some embodiments of the disclosure has been presented for purposes of illustration and description. The description is not intended to be exhaustive or to limit the disclosure to the precise form disclosed, and modifications and variations are possible in light of the above teachings. The specifically described embodiments explain the principles and practical applications to enable one ordinarily skilled in the art to utilize various embodiments and with various modifications as are suited to the particular use contemplated. Various changes, substitutions and alterations can be made hereto without departing from the spirit and scope of the disclosure.

1-10. (canceled)

11. A motor vehicle component, comprising:
a hot formed and press hardened steel sheet plate;
a reinforcement patch which forms a double layer with the steel sheet plate; and
an opening which extends through the reinforcement patch and the steel sheet plate, wherein
an edge area surrounding the opening is embossed on the steel sheet plate or the reinforcement patch so as to be set back from a surface of the steel sheet plate or the reinforcement patch.

12. The motor vehicle component according to claim 11, wherein the edge area comprises an indentation which is recessed, relative to the surface by 4% to 40% of a wall thickness of the steel sheet plate or of the reinforcement patch having the indentation.

13. The motor vehicle component according to claim 11, wherein the indentation extends radially circumferentially from the opening in a transverse direction by at least 0.5 mm.

14. The motor vehicle component according to claim 11, wherein a hole edge of the opening has a burr after press hardening, and a length of the burr is less than 0.3 mm.

15. The motor vehicle component according to claim 11, wherein a wall of the opening has a smooth cut proportion greater than 25% of the wall of the entire opening.

16. The motor vehicle component according to claim 11, further comprising a collar on a rear side of one of the steel sheet plate and the reinforcement patch that has the embossed edge area, wherein the collar projects into a wall of the other of the steel sheet plate and the reinforcement patch.

17. The motor vehicle component according to claim 11, wherein a piercing nut is inserted into the opening, and hot cutting of the opening is performed by the piercing nut.

18. A method of making a motor vehicle component, the method comprising:
coupling a steel sheet plate and a reinforcement patch so the steel sheet plate and the reinforcement patch form a double layer, wherein at least one of the steel sheet plate or the reinforcement patch includes hardenable steel alloy;
heating the double layer to above Ac3 temperature;
forming an indentation in a surface of the steel sheet plate or the reinforcement patch;
hot forming;
hot cutting, wherein a cutting tool cuts on a back of the indentation and ejects a cutout on a side of the indentation, to obtain an opening which extends through the reinforcement patch and the steel sheet plate; and
press hardening of the formed motor vehicle component, wherein
the indentation is formed after the heating, during or immediately after the hot forming,
the hot cutting is performed during or after the hot forming, and
an edge area surrounding the opening and corresponding to the indentation is embossed on the steel sheet plate or the reinforcement patch so as to be set back from the surface of the steel sheet plate or the reinforcement patch.

19. The method according to claim 18, wherein the hot cutting is performed at a temperature between 500° C. and 770° C.

20. The method according to claim 18, wherein the indentation is flat or the indentation is annular.

21. The motor vehicle component according to claim 11, wherein the edge area comprises an indentation which is recessed, relative to the surface, by 8% to 35% of a wall thickness of the steel sheet plate or of the reinforcement patch having the indentation.

22. The motor vehicle component according to claim 11, wherein the edge area comprises an indentation which is recessed, relative to the surface, by 12% to 30% of a wall thickness of the steel sheet plate or of the reinforcement patch having the indentation.

23. The motor vehicle component according to claim 11, wherein the indentation extends radially circumferentially from the opening in a transverse direction by more than 1 mm.

24. The motor vehicle component according to claim 11, wherein a hole edge of the opening has a burr after press hardening, and a length of the burr is less than 0.2 mm.

25. The motor vehicle component according to claim 11, wherein a wall of the opening has a smooth cut proportion greater than 40% of the wall of the entire opening.

26. The method according to claim 18, wherein the hot cutting is performed at a temperature between 600° C. and 730° C.
